(19) United States
(12) Patent Application Publication
(10) Pub. No.: US 2020/0302135 A1
(43) Pub. Date: Sep. 24, 2020

(54) METHOD AND APPARATUS FOR LOCALIZATION OF ONE-DIMENSIONAL BARCODES

(71) Applicant: Sasken Technologies Ltd, Bangalore, KA (US)

(72) Inventor: Smriti Nirmala, Bangalore (IN)

(21) Appl. No.: 16/571,324

(22) Filed: Sep. 16, 2019

(30) Foreign Application Priority Data
Mar. 19, 2019 (IN) 201941010691

(51) Int. Cl. G06K 7/14; G06T 7/70; G06T 7/11; G06T 7/136; G06T 7/155; G06K 7/10

(52) U.S. Cl. CPC G06K 7/1413; G06T 7/70; G06T 7/11; G06T 2207/20036; G06T 7/155; G06K 7/10722; G06T 7/136

(57) ABSTRACT

The proposed method and apparatus localizes one or more one-dimensional barcodes present in a digital image. The method uses a line segment detection algorithm detecting line segments in the digital image. Further, the line segments detected are clustered together as belonging to probable barcodes based on the orientation and distance between each line segment. The line segments in a cluster are joined by growing a ray in the direction perpendicular to the line segments. Further, the various clusters are subjected to connected component analysis in order to identify valid barcodes. Further, the location of the barcode and the bounding box details of the barcode are returned. Based on the location and bounding box details, the barcode may be read using barcode readers.

### FIELD OF INVENTION

The present disclosure is related to image-based barcode reading and more particularly to localization of one-dimensional (1-D) barcodes present in a digital image. The present application is based on, and claims priority from an Indian Application Number 201941010691 filed on 19 Mar., 2019 the disclosure of which is hereby incorporated by reference herein.

### BACKGROUND OF THE INVENTION

Today, barcode technology is being successfully used for tracking and identification of objects. Because of the ease and low cost associated with the technology, barcodes have been adopted in commerce such as stores hospitals, banks, factories, warehouses and so on.

Currently, barcode are read robustly using dedicated barcode readers. In recent times there has also been a growing interest in image-based barcode readers. Typically, image-based barcode reading applications enable smart phone users to read barcodes using their phone camera and thus access product details encoded by the barcode. But, the current image-based barcode reading applications are unable to process low resolution images and images taken in low light conditions. Further, the existing barcode reading applications also fail to process barcodes that are out of focus in the image or when the camera is not close enough to the barcode. Further, the existing barcode reading applications also fail to detect the presence of multiple barcodes in an image. The demand for image-based barcode readers in industrial setups is also on the rise, where the barcode reader is expected to read all the barcodes in an image captured by a surveillance camera having a large field-of-view. Another challenge is the unknown viewpoint from which the barcode image has been captured.

An IEEE paper titled ‘A New Method of Angle-Robust Multiple 1-D Barcodes Detection’ by Zhou et al presents an angle robust 1-D barcode detection algorithm. The algorithm starts with line selection from a binarized image. The orientation of the lines so detected is used to define an orientation accumulator for determining dominant orientation of each cluster of barcodes. Further, orientation rectification of each barcode is performed and a gradient map is calculated to highlight the barcode region. The highlighted barcode regions are further used to accelerate the barcode detection.

U.S. Pat. No. 8,608,073B2 describes a technique for the detection of multiple 1-D barcodes in an image. The technique involves partitioning the image into sub-images. Each sub-image is then processed to check if it contains at least a portion of the barcode. The presence of barcode in a sub-image is determined based on a predetermined density threshold, predetermined parallel line threshold and a predetermined line count threshold. A single barcode may comprise of multiple sub-images each of which contains at least a portion of the barcode.

U.S. Pat. No. 8,439,260B2 describes a method for 1-D barcode localization as well as decoding using a general camera. It is suggested that the barcode be within the viewfinder rectangle displayed on the camera screen. Each row is scanned for edge information till a valid barcode format is detected.

U.S. Pat. No. 8,366,004B2 describes a method for barcode localization based on various morphological operations on edge map and low intensity map. Here also the barcodes are suggested to be captured within the viewfinder rectangle displayed on the camera screen.

U.S. Pat. No. 7,946,491B2 describes a barcode detection technique assuming that barcode overlaps with the center of the captured image. Thus, where a large number of edges are detected also corresponds to an area near the center of the captured image is assumed to be the barcode.

U.S. Pat. No. 9,098,764B2 describes a localization technique that assumes the image of the barcode is captured with the camera oriented in such a way that its vertical axis is parallel to the barcode lines. The edge map is obtained and smoothened using a block filter. The size of the block size is selected based on minimum size of the barcode readable by the method. The smoothened version so obtained is subjected to image thresholding and thus the barcode is localized.

In summary, some existing methods depend on capturing the barcode exactly in the viewfinder rectangle that is displayed on the screen. Other existing methods use filters or morphological operation, whose kernels have to be chosen based on the size of the barcodes to be processed. This makes handling multiple barcodes, each of a different size, challenging. Most of the existing methods encounter a thresholding or edge detection step, which are highly dependent on the illumination conditions under which the image was captured. Further, some of the existing techniques do not handle barcodes of all orientations within the image.

### BRIEF SUMMARY OF THE INVENTION

This summary is provided to introduce a selection of concepts in a simple manner that is further described in the detailed description of the disclosure. This summary is not intended to identify key or essential inventive concepts of the subject matter nor is it intended for determining the scope of the disclosure.

An example of a method for localizing one or more one-dimensional barcodes in a digital image for enabling a barcode reader to read the one or more barcodes in the digital image is disclosed. The method comprises receiving the digital image by a processor, converting the received digital image into a gray-scale image, by the processor, identifying line segments in the gray-scale image, by the processor, converting the gray-scale image into a binary image, by the processor, clustering consecutive line segments parallel to one another, in the binary image, when a distance between centroids of the consecutive line segments is not more than a predefined value by the processor, identifying the one or more barcodes present in the digital image, by connected component analysis of the binary image after clustering, by the processor, and calculating at least one of location information and bounding box information of each the identified one or more barcodes, by the processor, for communicating to the barcode reader.

An example of an apparatus for localizing one or more one-dimensional barcodes in a digital image for enabling a barcode reader to read the one or more barcodes in the digital image. The apparatus comprises a memory and a processor electrically and communicatively coupled to the memory. The processor is configured for executing program instructions stored in the memory for receiving the digital image, converting the received digital image into a gray-scale image, identifying line segments in the gray-scale image, converting the gray-scale image into a binary image, clustering consecutive line segments parallel to one another, in the binary image, when a distance between centroids of the consecutive line segments is not more than a predefined value. Further, the processor is configured for executing program instructions stored in the memory for identifying the one or more barcodes present in the digital image, by connected component analysis of the binary image after clustering, and calculating at least one of location information, and bounding box information of each of the identified one or more barcodes for communicating to the barcode reader.

To clarify the advantages and features of the present disclosure further, a more particular description of the disclosure is rendered by reference to specific embodiments thereof, which is illustrated in the appended figures. It is to be appreciated that these figures depict only typical embodiments of the disclosure and are therefore not to be considered limiting of its scope. The disclosure is described and explained with additional specificity and detail with the accompanying figures.

### BRIEF DESCRIPTION OF FIGURES

The disclosure is described and explained with additional specificity and detail with the accompanying figures in which:

FIG. 1A illustrates functional block diagram of an apparatus for identifying 1-D barcodes, in accordance with a first embodiment of the present disclosure;

FIG. 1B illustrates functional block diagram of a Segmentation and clustering block, in accordance with the first embodiment of the present disclosure;

FIG. 1C illustrates functional block diagram of a Line Segment Detection Block, in accordance with the first embodiment of the present disclosure;

FIGS. 2A, 2B, and 2C show a method for line segment detection, in accordance with the first embodiment of the present disclosure;

FIGS. 2D, 2E, and 2F show a method for line segment clustering, in accordance with the first embodiment of the present disclosure;

FIGS. 3A to 3E illustrate various stages of barcode localization in a first sample digital image, in accordance with the first embodiment of the present disclosure;

FIGS. 4A to 4E illustrate various stages of barcode localization in a second sample digital image, in accordance with the first embodiment of the present disclosure;

FIG. 5 shows a method for localization of one or more barcodes in a digital image, in accordance with the first embodiment of the present disclosure;

FIG. 6 illustrates functional block diagram of an apparatus for identifying 1-D barcodes, in accordance with a second embodiment of the present disclosure;

FIG. 7 shows a method for localization of one or more barcodes in a digital image, in accordance with the second embodiment of the present disclosure; and

FIGS. 8A to 8D illustrate various stages of barcode localization in a second sample digital image, in accordance with the second embodiment of the present disclosure.

Further, persons skilled in the art to which this disclosure belongs may appreciate that elements in the figures are illustrated for simplicity and may not have been necessarily been drawn to scale. Furthermore, in terms of the construction of the apparatus, one or more components of the apparatus may have been represented in the figures by conventional symbols, and the figures may show only those specific details that are pertinent to understanding the embodiments of the present disclosure so as not to obscure the figures with details that are readily apparent to those of ordinary skill in the art having benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications to the disclosure, and such further applications of the principles of the disclosure as described herein being contemplated as would normally occur to one skilled in the art to which the disclosure relates are deemed to be a part of this disclosure.

[symbol]

It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or a method. Similarly, one or more devices or sub-systems or elements or structures or components preceded by “comprises . . . a” does not, without more constraints, preclude the existence of other devices, other sub-systems, other elements, other structures, other components, additional devices, additional sub-systems, additional elements, additional structures, or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this disclosure belongs. The apparatus, methods, and examples provided herein are illustrative only and not intended to be limiting.

The present disclosure discloses a method and apparatus for the precise localization of multiple 1-D barcodes in a digital image. The method involves the use of an existing line segment detection algorithm and a novel line segment clustering technique for localization of the barcodes.

Embodiments of the present disclosure will be described below in detail with reference to the accompanying figures.

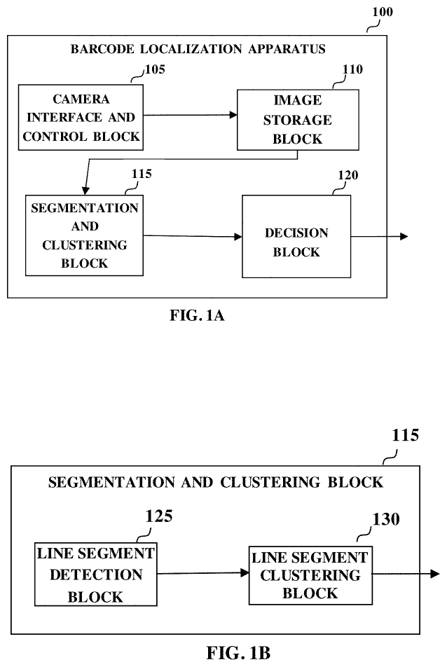

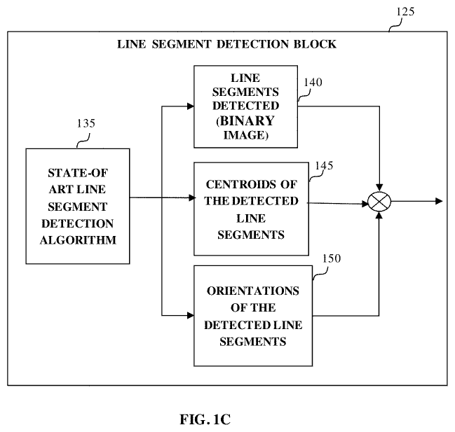

With reference to FIG. 1A, 1B, and 1C, functional block diagram of an apparatus 100 for localization of one or more 1-D barcodes in a digital image is shown, in accordance with a first embodiment of the present disclosure. The apparatus 100 comprises a camera interface and control block 105, an image storage block 110, a segmentation and clustering block 115 and a decision block 120.

The camera interface and control block 105 enables the apparatus 100 to be interfaced with an image/video capturing device (not shown). Non-limiting examples of the image/video capturing device include a mobile phone camera, a surveillance camera and so on. The image/video capturing device may be operably connected to the apparatus 100 and communicate with the apparatus using wired or wireless interfacing standards. Non-limiting examples of interfacing standards may include capture boards, FireWire, Camera Link®, GigE and USB. The image storage block 110 stores the images received from the image/video capturing device for processing by the segmentation and clustering block 115.

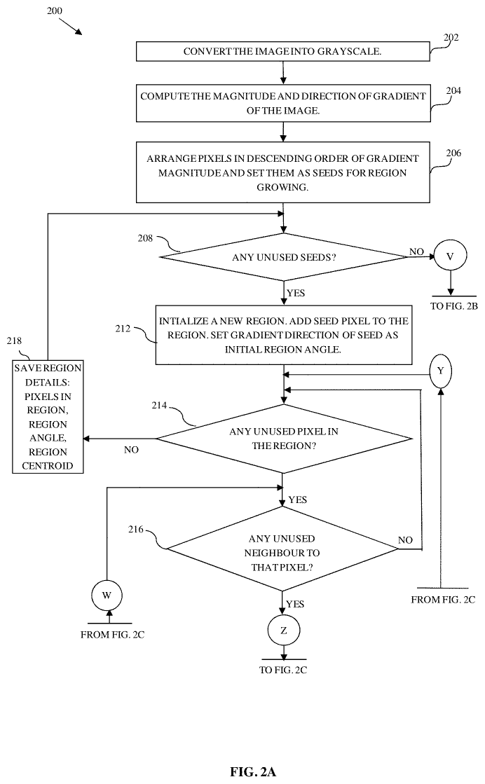

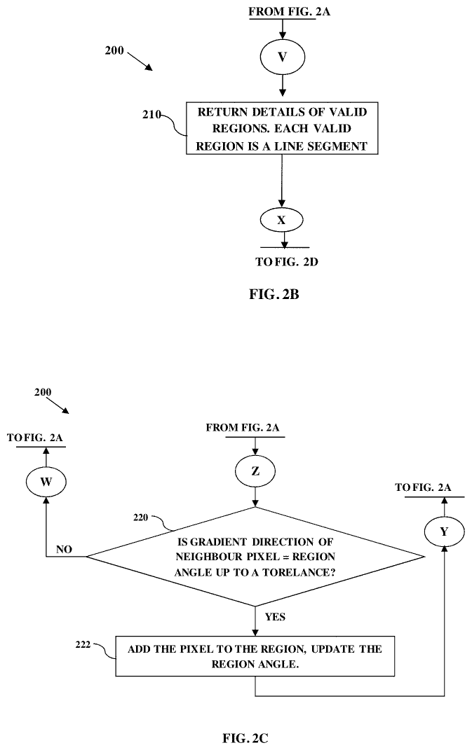

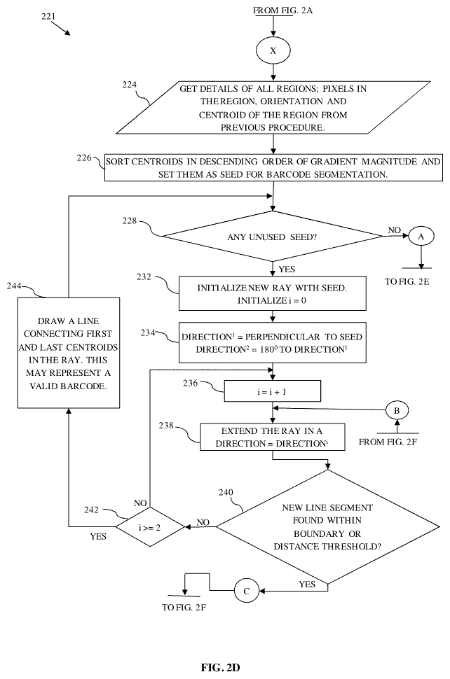

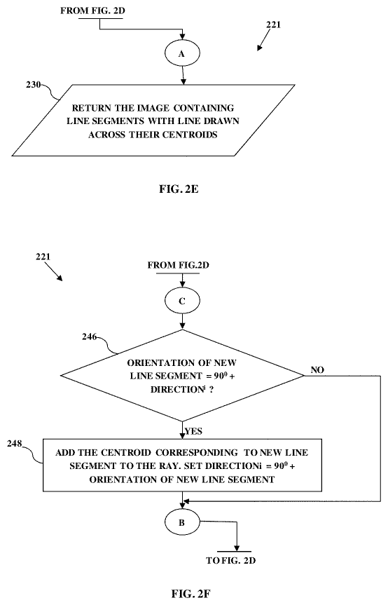

The segmentation and clustering block 115 comprises a line segment detection block 125 and a line segment clustering block 130 as shown in FIG. 1B. The line segment detection block 125 fetches the digital image stored in the image storage block 110 for processing. Upon fetching the line segment detection block 125 runs a suitable line segment detection algorithm 135 on the digital image for generating: a binary image 140 in which a pixel value TRUE indicates the presence of a line segment and a pixel value FALSE indicates the absence of a line segment, centroids 145, and orientations 150 of each of the line segments detected, as shown in FIG. 1C. The orientation may be defined as the angle of the line segment with reference to any chosen point on the digital image as the origin and the edges of the digital image, at right angle to each other, as the axes. In one example, the origin may be the top-left corner of the digital image for the ease of having positive values for coordinates. Any other suitable point however, may also be chosen as the origin. The functionality of the line segment detection block 125 is explained in detail with reference to FIGS. 2A, 2B and 2C. The outputs of the line segment detection block 125 are processed further by the line segment clustering block 130 for segmentation of the barcodes present in the digital image whose functioning is explained with reference to FIG. 2D, 2E, and 2F.

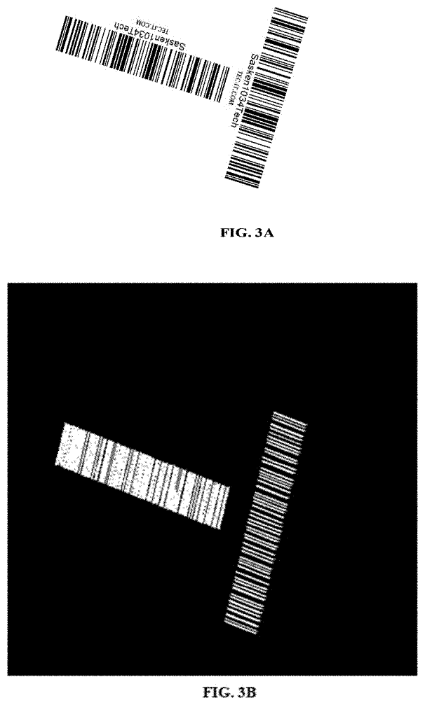

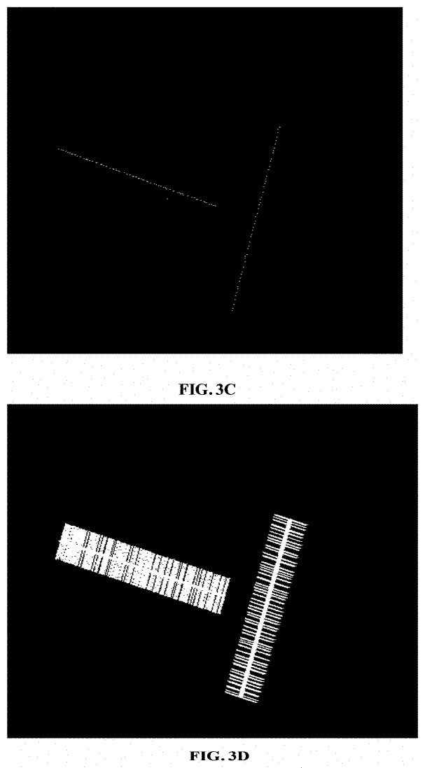

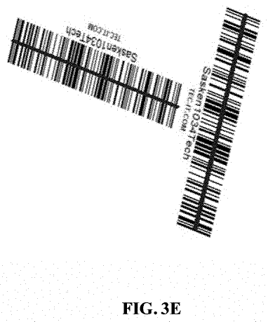

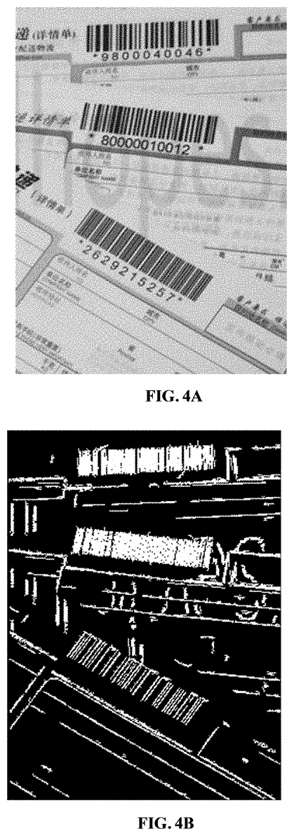

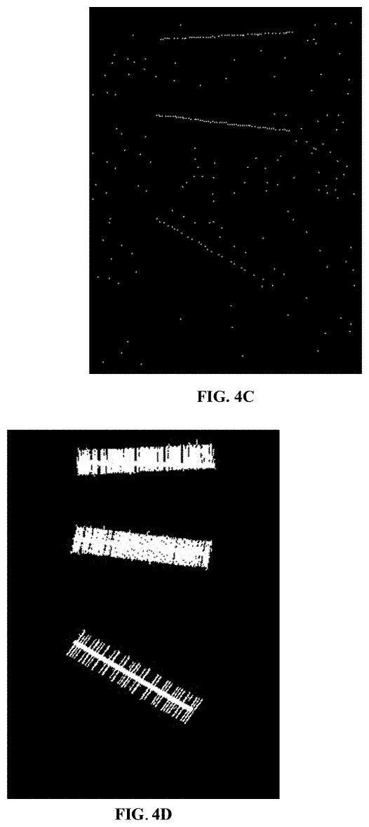

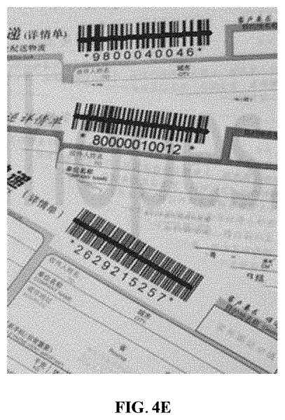

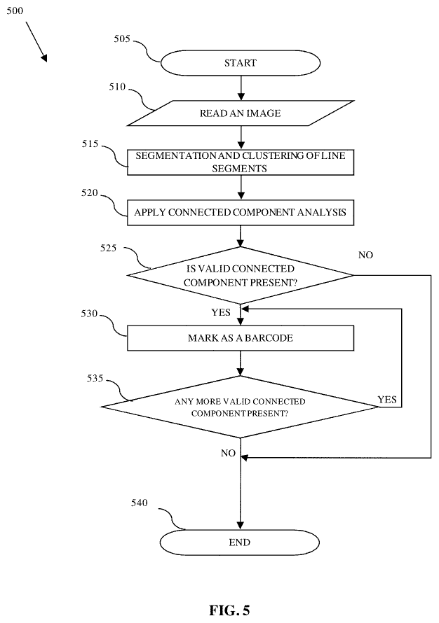

The output of the segmentation and clustering block 115 is further processed by the decision block 120. More specifically, the decision block 120 performs a connected component analysis on the binary image 140. Based on the connected components detected during the analysis and certain predefined conditions, the decision block 120 determines whether the various connected components detected are valid barcodes or not. For example, consider that the digital image consists of a sentence, “I'll do that”. Here, it is possible that the term “I'll” is erroneously considered as a barcode, thus resulting in a false positive result. In order to avoid such false positives, conditions may be predefined to check the number of lines in a candidate barcode or the area of the candidate barcode. For example, if the area of a patch detected as a barcode in the binary image output is less than a given threshold, say 10% of the largest barcode found, the decision block 120 rejects the patch from being considered as a barcode. In another example, if the number of lines in the patch detected as a barcode is less than a given threshold, say, seven lines, the decision block 120 rejects the patch from being considered as a barcode. Further the decision block 120 returns the location information of the barcode in the digital image and also the bounding box information of the barcodes. The bounding box information may include the orientation of the barcode, coordinates of points defining a rectangle bounding the barcode, and so on, for each of the barcodes in the digital image. The process has been explained by taking an example as shown in FIGS. 3A to 3E and another example as shown in FIGS. 4A to 4E.

Referring to FIG. 2A to 2C, in conjunction with FIGS. 1A to 1C, a method 200 for line segment detection is described. At first, the line segment detection block 125 accesses and reads a digital image stored in the image storage block 110. In one example, the digital image may be a color image (sample image as shown in FIG. 3A or 4A). The method 200 comprising steps 202 to 222 is implemented by the line segment detection block 125.

At step 202, the digital image is converted to a grayscale image.

At step 204, the gradient of the grayscale image is calculated. In one implementation, the gradient is calculated using 2×2 masks as shown below:

Using masks as shown above, the gradient magnitude and gradient direction are computed as follows:

$$\begin{matrix}gradient direction , θ ( x , y ) = arctan ( \frac{g x ( x , y )}{g y ( x , y )} ) & ( 1 ) \\ gradient magnitude , G ( x , y ) = \sqrt{g {x ( x , y )}^{2} + g {y ( x , y )}^{2}} & ( 2 )\end{matrix}$$

At step 206, the pixels in the grayscale image are sorted in descending order of gradient magnitude. Further, pixels with gradient magnitude less than a threshold are eliminated from further processing. The remaining sorted pixels are set as seeds for region growing. Each region so grown represents a line segment.

At step 208, the line segment detection block 125 determines whether there are any unused seeds. The unused seed may be defined as a pixel which has not been used for region growing. If unused seeds are not present, details of the valid region are returned as shown in step 210. Each valid region is a line segment. The region is classified as a line segment if the direction of the minimum bounding rectangle of the region and the region angle θ^{region} are equal with a tolerance of up to π/8 radians. The region angle, θ^{region} is calculated as:

$${θ}^{region} = arctan ( {\sum }_{j} \frac{sin ( gradient {direction}_{j} )}{cos ( gradient {direction}_{j} )} ) \qquad ( 3 )$$

where index j represents all pixels in the region.

Once a new region is formed, the minimum bounding rectangle associated with the region is found. The centroid of the region is chosen as the centroid of the rectangle. The centroid is set to (cₓ, c_{y}) where

$$\begin{matrix}{c}_{x} = \frac{{Σ}_{j ∈ R e g i o n} G ( j ) . x ( j )}{{Σ}_{j ∈ R e g i o n} G ( j )} & ( 4 ) \\ {c}_{y} = \frac{{Σ}_{j ∈ R e g i o n} G ( j ) . y ( j )}{{Σ}_{j ∈ R e g i o n} G ( j )} & ( 5 )\end{matrix}$$

where G(j) is the gradient magnitude of pixel j and the index j runs over all pixels in the region. The orientation of the axis along the length of the rectangle is taken as the direction of the Eigen vector associated with the largest Eigen value of the covariance matrix of the region. To find the Eigen vectors associated with the region, the associated covariance matrix is computed as

$$\begin{matrix}M = ( \begin{matrix}{m}^{xx} & {m}^{x y} \\ {m}^{x y} & {m}^{y y}\end{matrix} ) & ( 6 ) \\ where , & \\ {m}^{xx} = \frac{{Σ}_{j ∈ Region} G ( j ) . {( x ( j ) - {c}_{x} )}^{2}}{{Σ}_{j ∈ Region} G ( j )} & ( 7 ) \\ {m}^{y y} = \frac{{\sum }_{j ∈ R e g i o n} G ( j ) . {( y ( j ) - {c}_{y} )}^{2}}{{\sum }_{j ∈ R e g i o n} G ( j )} & ( 8 ) \\ {m}^{xy} = \frac{{\sum }_{j ∈ R e g i o n} G ( j ) . ( x ( j ) - {c}_{x} ) ( y ( j ) - {c}_{y} )}{{\sum }_{j ∈ R e g i o n} G ( j )} & ( 9 )\end{matrix}$$

Based on the covariance matrix, the Eigen values and corresponding Eigen vectors are computed. Further, the Eigen vector corresponding to the largest Eigen value is chosen and the direction of that Eigen vector is computed as shown in the example below. Let the chosen Eigen vector be

$${V}_{λ} = \frac{{v}_{y}}{{v}_{x}} ,$$

the direction of the Eigen vector is arctan

$$( \frac{{v}_{y}}{{v}_{x}} ) .$$

The direction of the Eigen vector corresponds to the direction of the rectangle. The output of the line segment detection block 125 comprises a binary image, as shown in FIG. 3B or 4B, where the value of a pixel is TRUE if it belongs to a line segment and FALSE if the pixel does not belong to a line segment. If the region is successfully classified as a line segment, the following are calculated: coordinates (x, y) of each pixel in the line segment, centroid and orientation of the line. The coordinates(x, y) are calculated with reference to the origin chosen on the digital image. The values thus calculated along with the binary image are provided to the line segment clustering block 130, as explained with reference to FIGS. 2D, 2E, and 2F.

If unused seeds are found in step 208, a new region is initialized by adding a seed pixel to the new region, as shown in step 212. The angle of the region is set as the gradient of the seed.

At step 214, the line segment detection block 125 determines whether there are any unused pixels in the region formed in step 212. If unused pixels are present, step 216 is performed. Otherwise, the region details such as pixels in the region, region angle, and the centroid of the region are saved as shown in step 218. Upon saving the region details, step 208 is performed again.

At step 216, the line segment detection block 125 determines whether there are any unused pixels neighboring the unused pixel identified in step 214. If there are neighboring unused pixels, step 220 is performed. Otherwise, step 214 is repeated to identify other unused pixels present in the region.

At step 220, the line segment detection block 125 determines whether the unused pixel identified in step 214, and the neighboring unused pixel identified in the 216 have a gradient direction which is similar in value to that of a region angle associated with the region. If the gradient direction is similar in value to that of the region angle, step 222 is performed. In one implementation, the gradient direction is determined to be similar to the region angle when the difference between the gradient direction and the region angle is less than π/32. Otherwise, if the gradient direction is not similar to a region angle associated with the region in step 220, step 216 is repeated.

At step 222, the pixels are added to the region and the region angle is updated based on the added pixels. Further, step 214 is repeated.

As may be understood, the steps 214 to 220 are performed repeatedly till all pixels added to the region are exhausted.

Referring to FIGS. 2D to 2F, in conjunction with FIGS. 1A to 1C, and FIGS. 2A to 2C, a method 221 for line segment clustering is described. The method 221 is implemented using the line segment clustering block 130. The line segment clustering procedure enables the segmentation of each barcode present in the digital image.

At step 224, the line segment clustering block 130 receives the coordinates (x, y) of each pixel in the line segment, centroid, and orientation of the line segments in the binary image (from step 210 of FIG. 2B). The FIGS. 3C, and 4C show the centroids of the binary images shown in FIGS. 3B, and 4B respectively.

At step 226, the centroids are sorted in descending order of gradient magnitude, in order to set the centroids as seeds for barcode segmentation.

At step 228, the line segment clustering block 130 determines whether there are any unused seeds in the sorted centroids. If no unused seeds are present, step 230 is performed. Otherwise, if unused seeds are present, step 232 is performed.

At step 230, the line segment clustering block 130 returns the binary image containing line segments, with the centers of the line segments joined to form a line perpendicular to the line segments, as shown in FIG. 3D or 4D. More specifically, the line segment clustering block 130 provides the binary images to the decision block 120, in this step.

At step 232, a ray is initialized for the unused seed. Further, a variable ‘i’ is set to i=0.

At step 234, a first direction Direction1 of the ray is set as perpendicular to the direction of the seed, that is, to the orientation of the line segment associated with the unused seed, and a second direction Direction2 is set as 180o to the first direction Direction1. Further, the value of i is incremented as shown in step 236. Upon incrementing i, the direction of the ray is set to Direction=Directioni as shown in step 238. Here, the direction of the ray is set to the first direction Direction1. Further, the ray is grown in the set direction till it reaches another line segment within a predefined value. The predefined value specifies a maximum allowable distance between centroids of any two parallel line segments beyond which the line segments may not be clustered.

At step 240, the line segment clustering block 130 determines whether a line segment is present within the predefined value or a boundary. If the new line segment is present, step 246 is performed. Otherwise, step 242 is performed.

At step 242, the value of i is verified to determine whether i>=2. If i>=2, step 244 is performed. Otherwise, step 236 is repeated.

At step 244, a line is drawn to join the centroids of the first and last line segments identified in the steps 228 to 240, to represent a one-dimensional barcode. Further, step 228 is repeated.

At step 246, the orientation of the new line segment is checked to see if it is perpendicular to the current direction of the ray. If the orientation is perpendicular to the direction of the ray, step 248 is performed. Otherwise, step 238 is repeated.

At step 248, the centroid of the new line segment is added to the ray. Further, Directioni is set to 90o+orientation of the new line segment. Further, step 238 is repeated.

The method 200 returns a binary image containing probable barcodes, as indicated in step 230. Each probable barcode in the binary image is represented as a connected entity as shown in FIG. 3E or 4E. In the presented examples, the localization is marked by a thick blue line running through the center of the detected barcode. Further, the binary image is subjected to connected component analysis by the decision block 120, as explained earlier with reference to FIG. 1A, in order to identify, and localize valid barcodes. Based on the results of the connected component analysis, the location of the valid barcode on the binary image is identified. Further, the bounding box information of the valid barcode are also calculated using the location information. As mentioned earlier, the bounding box information may include the coordinates defining a rectangle bounding the barcode, the orientation of the barcode, and so on. The location information and bounding box information of the barcodes are further used by image-based scanners to read the information encoded in the barcodes.

Referring to FIG. 5, in conjunction with FIGS. 1A to 1C, and 2A to 2F, a method 500 for localization of one or more 1-D barcodes in a digital image is described.

The method starts at step 505.

At step 510, a digital image captured by an image/video capturing device and stored in the image storage block 110, is read by the segmentation and clustering block 115.

At step 515, barcode localization is performed, by the segmentation and clustering block 115, as explained earlier using the method 200.

At step 520, the decision block 120 performs connected component analysis on the output of the segmentation and clustering block 115.

At step 525, the decision block 120 determines whether there are valid connected components present. In one example, the validity of the connected component may be determined based on the length of the ray passing through the connected component. If valid connected components are present, step 530 is performed. Otherwise, step 540 is performed.

At step 530, the decision block 120 marks the valid connected component as a barcode. Further, the location information and bounding box information of the barcode are identified and returned. The location information and bounding box information of each of the barcodes may be used by a barcode scanner for reading the information encoded in each of the barcodes.

At step 535, the decision block 120 determines whether there are any more valid connected components present. If valid connected components are present, step 530 is repeated. Otherwise, step 540 is performed.

The method ends at step 540.

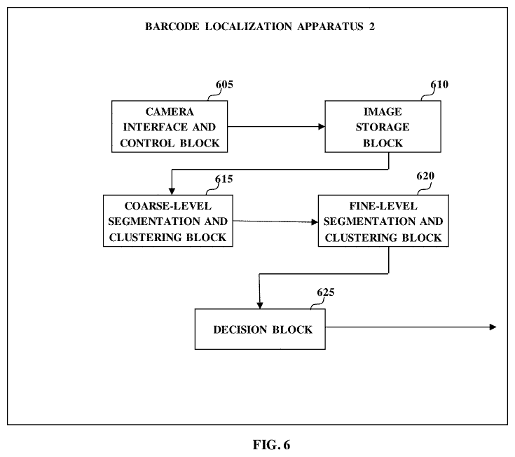

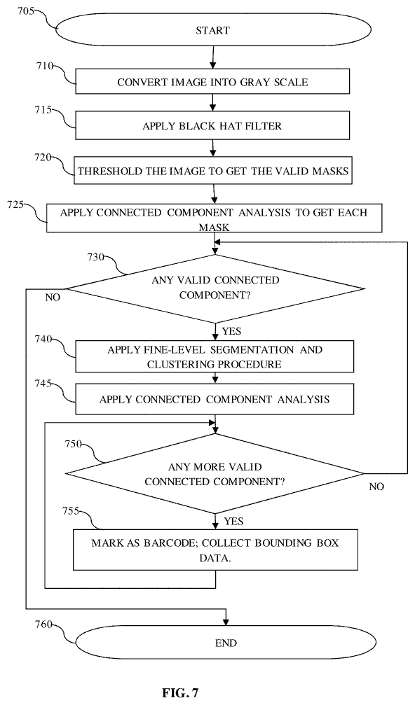

Referring to FIG. 6, a functional block diagram of an apparatus 600 for localization of one or more 1-D barcodes in an image is shown, in accordance with a second embodiment of the present disclosure. The apparatus 600 comprises a camera interface and control block 605 (similar to the camera interface and control block 105), an image storage block 610 (similar to the image storage block 110), a coarse-level segmentation and clustering block 615, a fine-level segmentation and clustering block 620 (similar to segmentation and clustering block 115), and a decision block 625 (similar to decision block 120).

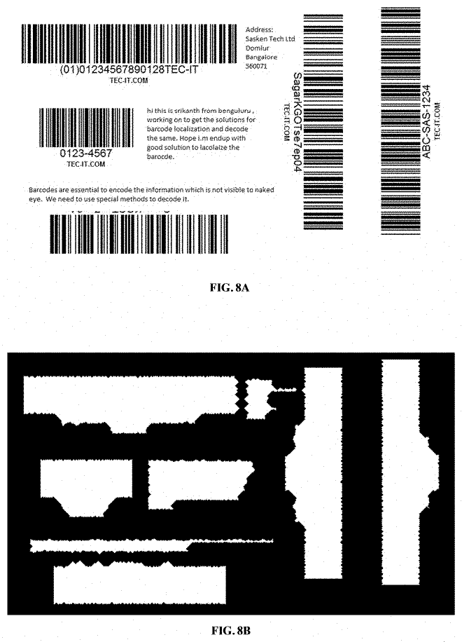

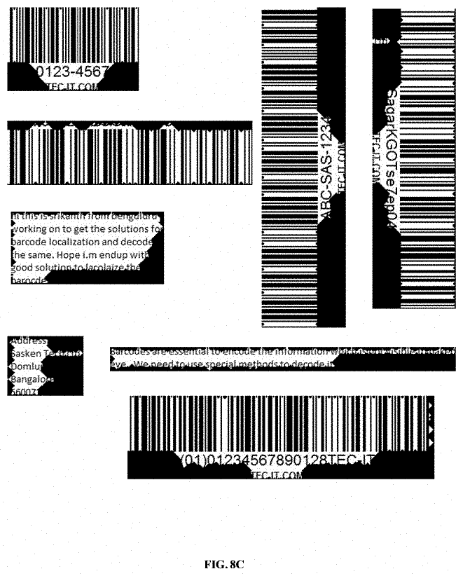

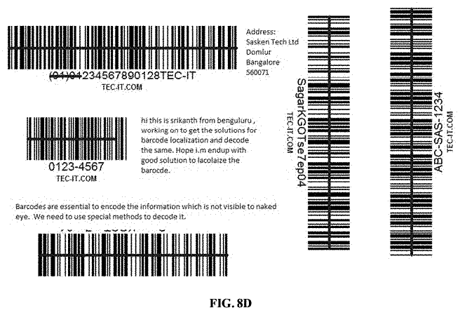

The apparatus 600 is particularly useful in cases where the input image size is large and multiple barcodes are spread across the digital image, for example, the digital image shown in FIG. 8A. In the present embodiment, instead of running the barcode localization procedure over the whole digital image as in the previous embodiment, the coarse-level segmentation and clustering block 615 identifies probable regions in the digital image where barcodes may be present. More specifically, the coarse-level segmentation and clustering block 615 takes the digital image from the image storage block 610 and performs initial segmentation on the digital image in order to retrieve the probable regions in the digital image where barcodes may be present. Further, the fine-level segmentation and clustering block 620 localizes barcodes, precisely, in the probable regions given by the coarse-level segmentation and clustering block 615. The fine-level segmentation and clustering block 620 employs a method similar to method 200 in order to localize the barcodes. Further, the decision block 625 performs connected component analysis on the digital image returned by the fine-level segmentation and clustering block 620. The decision block 625 then returns the location information and bounding box information of the barcodes identified in the digital image, as explained in the previous method.

Referring to FIG. 7, in conjunction with FIG. 6, another method 700 for localization of one or more 1-D barcodes in a digital image is described. The method 700 is implemented using the apparatus 600 as explained earlier.

The method starts at step 705 where a digital image stored in the image storage block 610 is accessed and read by the coarse-level segmentation and clustering block 615. For example, consider that the digital image is the one shown in FIG. 8A

At step 710, the digital image is converted to a grayscale image, by the coarse-level segmentation and clustering block 615.

At step 715, the coarse-level segmentation and clustering block 615 performs a morphological operation on the grayscale image. In one embodiment, the morphological operation is a black-hat filter operation. The black-hat filter operation highlights the bright regions in an image, and is applied to the grayscale image with the assumption that the region around the barcode is the brightest in the grayscale image. The assumption holds true for most real world situations.

At step 720, the coarse-level segmentation and clustering block 615 runs a morphological closing operation on the filtered image from step 715. Further, image thresholding is performed on the filtered image to obtain a binary image comprising masks as shown in FIG. 8B. In one example, the image thresholding may be performed using Otsu's method. The binary image comprises masks for all Regions of Interest. Each Region of Interest correspond to a probable barcode. FIG. 8C shows the Regions of Interest patches corresponding to each mask in FIG. 8B.

At step 725, the coarse-level segmentation and clustering block 615 performs connected component analysis on the thresholded image to identify each mask in the binary image separately.

At step 730, the coarse-level segmentation and clustering block 615 determines whether there are any valid connected components in the binary image. If there are no valid components, step 760 is performed. Otherwise, step 740 is performed.

At step 740, each mask is fed separately to the fine-level segmentation and clustering block 620.

At step 745, the output of the fine-level segmentation and clustering block 620 is further subjected to connected component analysis at the decision block 625.

At step 750, the decision block 625 checks the result of the connected component analysis performed in step 745, to determine if valid connected components are present. If valid connected components are present, step 755 is performed. Otherwise, the step 730 is repeated.

At step 755, the valid connected component identified in step 750 is marked as a barcode. Further, the decision block 625 determines location data, and bounding box information of the barcode. Further, step 750 is repeated. FIG. 8D illustrates the final output of the apparatus 600. Here, the localization is marked by a thick blue line drawn across the barcodes.

The method ends at step 760.

It must be understood that the method for localization of one-dimensional barcodes described in the various embodiments, may be a computer-implemented method or a chip-based-implementation.

The methods for barcode localization disclosed above overcomes most of the drawbacks associated with existing barcode detection techniques. The invention is robust to blur, and illumination variations, as the method does not use thresholding for binarization or for edge detection. This is because when binarization or edge map is used in a barcode detection procedure, it leads to information loss, thus making the detection procedure sensitive to blur and illumination changes. Further, the method disclosed also helps in localization of multiple closely spaced 1-D barcodes of any size, in a digital image. The method and apparatus disclosed may be used along with existing image-based scanners for reading multiple barcodes at the same time. As mentioned earlier, the image-based scanners may read the barcodes based on the location data and bounding box information of the barcodes returned by the method disclosed. Hence, the method and apparatus for localization of 1-D barcodes disclosed herein, are capable of addressing non-ideal, real-life situations more robustly.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art may appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method for localizing one or more one-dimensional barcodes in a digital image for enabling a barcode reader to read the one or more barcodes in the digital image, the method comprising:
receiving the digital image by a processor;
converting the received digital image into a gray-scale image, by the processor;
identifying line segments in the gray-scale image, by the processor;
converting the gray-scale image into a binary image, by the processor;
clustering consecutive line segments parallel to one another, in the binary image, when a distance between centroids of the consecutive line segments is not more than a predefined value by the processor;
identifying the one or more barcodes present in the digital image, by connected component analysis of the binary image after clustering, by the processor; and
calculating at least one of location information and bounding box information of each of the identified one or more barcodes, by the processor, for communicating to the barcode reader.

2. The method as claimed in claim 1, wherein the step of converting the gray-scale image into the binary image comprises:
filtering the grayscale image, by applying a morphological operation on the gray-scale image, by the processor; and
thresholding the filtered image for masking one or more Regions of Interest in the filtered image, by the processor, wherein each Region of Interest corresponds to a probable barcode,

3. The method as claimed in claim 2, comprising segmentation of the masked Regions of Interest, by the processor, by connected component analysis of the filtered image after thresholding.

4. The method as claimed in claim 2, wherein the morphological operation is black-hat filter operation.

5. The method as claimed in claim 2, wherein the filtered image is thresholded using Otsu thresholding technique.

6. The method as claimed in claim 1, comprising transmitting, by the processor, at least one of the location information and the bounding box information of each of the one or more barcodes, to a barcode reader for reading information encoded in each of the one or more barcodes.

7. The method as claimed in claim 1, wherein a pixel value TRUE indicates the presence of a line segment in the binary image and a pixel value FALSE indicates the absence of a line segment in the binary image.

8. The method as claimed in claim 1, wherein consecutive line segments are clustered by drawing a ray through centroids of consecutive line segments and wherein the ray is drawn perpendicular to the orientation of the line segments.

9. The method as claimed in claim 1, wherein the bounding box information comprises at least one of an orientation of the barcode and a plurality of coordinates defining a rectangle bounding the barcode for each of the barcode in the digital image.

10. An apparatus for localizing one or more one-dimensional barcodes in a digital image for enabling a barcode reader to read the one or more barcodes in the digital image, the apparatus comprising:
a memory; and
a processor electrically and communicatively coupled to the memory, wherein, the processor is configured for executing program instructions stored in the memory for:
receiving the digital image;
converting the received digital image into a gray-scale image;
identifying line segments in the gray-scale image;
converting the gray-scale image into a binary image;
clustering consecutive line segments parallel to one another, in the binary image, when a distance between centroids of the consecutive line segments is not more than a predefined value;
identifying the one or more barcodes present in the digital image, by connected component analysis of the binary image after clustering; and
calculating at least one of location information, and bounding box information of each of the identified one or more barcodes for communicating to the barcode reader.

11. The apparatus as claimed in claim 10, wherein the apparatus is configured for converting the gray-scale image into the binary image by:
filtering the grayscale image by applying a morphological operation on the gray-scale image; and
thresholding the filtered image for masking one or more Regions of Interest in the filtered image, wherein each Region of Interest corresponds to a probable barcode.

12. The apparatus as claimed in claim 11, wherein the processor is configured for segmenting masked Regions of Interest by connected component analysis of the filtered image, after thresholding.

13. The apparatus as claimed in claim 11, wherein the morphological operation is black-hat filter operation.

14. The apparatus as claimed in claim 11, wherein the filtered image is thresholded using Otsu thresholding technique.

15. The apparatus as claimed in claim 10, wherein the processor is configured for executing program instructions stored in the memory for transmitting at least one of the location information and the bounding box information of each of the one or more barcodes to a barcode reader for reading information encoded in each of the one or more barcodes.

16. The apparatus as claimed in claim 10, wherein a pixel value TRUE is for indicating the presence of a line segment and a pixel value FALSE is for indicating the absence of a line segment, in the binary image.

17. The apparatus as claimed in claim 10, wherein consecutive line segments are clustered by drawing a ray through centroids of consecutive line segments, and wherein the ray is drawn perpendicular to the line segments.

18. The apparatus as claimed in claim 10, wherein the bounding box information comprises at least one of an orientation of the barcode and a plurality of coordinates defining a rectangular bounding the barcode for each of the barcodes in the digital image.
